(19) United States
(12) Patent Application Publication
(10) Pub. No.: US 2014/0098411 A1
(43) Pub. Date: Apr. 10, 2014

(54) RARE EARTH DOPED Lu2O3 POLYCRYSTALLINE CERAMIC LASER GAIN MEDIUM

(71) Applicants: Woohong Kim, Lorton, VA (US); Guillermo R. Villalobos, Springfield, VA (US); Colin C. Baker, Alexandria, VA (US); Jesse A. Frantz, Landover, MD (US); Leslie Brandon Shaw, Woodbridge, VA (US); Bryan Sadowski, Falls Church, VA (US); Jasbinder S. Sanghera, Ashburn, VA (US); Ishwar D. Aggarwal, Charlotte, NC (US)

(72) Inventors: Woohong Kim, Lorton, VA (US); Guillermo R. Villalobos, Springfield, VA (US); Colin C. Baker, Alexandria, VA (US); Jesse A. Frantz, Landover, MD (US); Leslie Brandon Shaw, Woodbridge, VA (US); Bryan Sadowski, Falls Church, VA (US); Jasbinder S. Sanghera, Ashburn, VA (US); Ishwar D. Aggarwal, Charlotte, NC (US)

(21) Appl. No.: 13/629,641

(22) Filed: Sep. 28, 2012

Related U.S. Application Data
(60) Provisional application No. 61/540,105, filed on Sep. 28, 2011.

(51) Int. Cl. H01S 3/16

(52) U.S. Cl. CPC H01S 3/1603
USPC 359/341.5; 264/681

(57) ABSTRACT

A method for making a rare earth doped polycrystalline ceramic laser gain medium by hot pressing a rare earth doped polycrystalline powder where the doping concentration is greater than 2% and up to 10% and where the grain size of the final ceramic is greater than 2 μm. The polycrystalline powder can be Lu₂O₃, Y₂O₃, or Sc₂O₃, and the rare earth dopant can be Yb³⁺, Er³⁺, Tm³⁺, or Ho³⁺. Also disclosed is the related rare earth doped polycrystalline ceramic laser gain medium prepared by this method.

### PRIORITY CLAIM

This Application claims priority from U.S. Provisional Application No. 61/540,105 filed on Sep. 28, 2011 by Woohong Kim et al., entitled “RARE EARTH DOPED LU₂O₃ POLYCRYSTALLINE CERAMIC LASER GAIN MEDIUM,” the entire contents of which are incorporated herein by reference.

### BACKGROUND OF THE INVENTION

1. Field of the Invention

The present invention relates generally to ceramic lasing and, more specifically, to high efficiency lasing from rare earth doped polycrystalline ceramics.

2. Description of the Prior Art

Since the first discovery of solid-state lasers in 1960, much effort has been focused on developing high quality laser gain materials mainly based on single crystals. (Maiman, “Simulated optical radiation in ruby,” Nature, 187, 493-94 (1960).) Since single crystals are generally grown from the melt, they suffer from major drawbacks such as segregation of the dopant from the host, optical inhomogeneity caused by stress during crystal growth and high cost and low productivity due to high temperature processing. It was not until 1964 that the first solid-state laser fabricated from polycrystalline ceramics using Dy:CaF₂ was reported. (Hatch et al., “Hot pressed polycrystalline CaF₂:Dy²⁺laser,” Appl. Phys. Lett., 5, 153-15 (1964).) Polycrystalline ceramics are advantageous over single crystals in many ways. The process is simple, cost effective, and typically carried out at a lower temperature. Also, much higher doping concentrations in ceramics can be obtained without phase segregation as is often observed in single crystals. (Ikesue et al., “Ceramic Laser Materials,” Nat. Photo., 2, 721-727 (2008).)

Currently, rare earth doped yttrium aluminum garnet (YAG) such as Nd:YAG and Yb:YAG is the most extensively studied and widely used for high power laser material. (Ikesue et al., “Fabrication and Optical Properties of High-Performance Polycrystalline Nd:YAG Ceramics for Solid-State Lasers,” J. Am. Ceram. Soc., 78 1033-1940 (1995); Lacovara et al., “Room-temperature diode-pumped Yb:YAG laser” Opt. Lett., 16(14) 1089-1091 (1991).) However, YAG is not the best host material for high-power laser operation systems due to its relatively low thermal conductivity and high thermal expansion. The sesquioxides such as Sc₂O₃, Y₂O₃, and Lu₂O₃ are very promising host materials for high-power laser applications, mainly due to their high thermal conductivity and high absorption and emission cross-sections of trivalent rare-earth ions in these materials. (Bolz et al., “Growth of high-melting sesquioxides by the heat exchanger method,” J. Cryst. Growth, 879, 237-239 (2002).) Among them, Lu₂O₃ may be preferred for Yb doped high power ceramic laser systems. Since the lutetium and ytterbium ions have very similar ionic radii and bonding forces, the ytterbium ion can easily replace a lutetium ion upon doping with the overall thermal conductivity being affected even at high doping concentration. Unfortunately, Lu₂O₃ has a very high melting point (>2400° C.) and is difficult to make in large sizes using traditional high-temperature melt-growth techniques. However, vacuum sintering can overcome these limitations and has been used to make transparent ceramic laser materials. (Lu et al., Appl. Phys. Lett., 81, 4324 (2002); Takachi at al., Phys. Status Solidi, B202, R1 (2005); Tokurakawa et al., Opt. Express, 14, 12832 (2006).)

The state of the art lasing data to date has been demonstrated in vacuum-sintered Lu₂O₃ ceramic made with a relatively low concentration of 3%. Lu et al. reported a 0.15% Nd³⁺ doped Lu₂O₃ ceramic that exhibited lasing at 1080 nm with an output power of 10 mW and an efficiency of 12%. Takachi et al. were the first to demonstrate cw lasing at 1035 nm with an output power of 700 mW and efficiency of 35% using a 3% Yb³⁺ doped Lu₂O₃ ceramic. A similar doped ceramic also exhibited pulsed lasing at 1033:5 nm (pulse width=357 ns, rep rate˜97 MHz) with an output power of 352 mW and efficiency of 32%. Kaminskii et al. were first to report lasing at around 1079 nm using 3% Yb³⁺ dopant in lutetia and with an output power of about 250 mW. (Kaminskii et al., Laser Phys. Lett., 3, 375 (2006).) To date, all the examples highlighted in the literature were made by vacuum sintering rather than hot pressing. Hot pressing could possibly provide a viable alternative pathway to manufacturing large ceramic laser materials. However, hot pressing generally results in a ceramic with relatively large grain sizes of several tens of microns. This grain size is considerably larger than the 1-2 μm size generally believed to be a prerequisite for laser oscillation in sintered ceramics as described in the literature. (Hosokawa et al., “Translucent lutetium oxide sinter, and method for manufacturing same,” U.S. Pat. No. 7,597,866 (Oct. 6, 2009).) Ohtomo et al. reported that an efficient laser oxcillation is not expected from ceramics (Nd:YAG and Yb:YAG) with larger grain size where the inherent segregation of transverse patterns into multiple local modes possessing different lasing profiles and polarization is observed. On the other hand, single-frequency linearly polarized emissions that were free from dynamic instabilities are achieved in microcrystalline ceramic samples, whose grain size was smaller than 5 μm. (Ohtomo et al., “Effect of Grain Size on Modal Structure and Polarization Properties of Laser-Diode-Pumped Miniature Ceramic Lasers,” Jap. J. Appl. Phys., 46 L1013-L1015 (2007).) The present invention is counterintuitive since high efficiency lasing was observed from hot pressed ceramic with grain size as large as 50 μm. Moreover, the record high efficiency was observed at extremely high doping concentration of 10%, which has never been observed from prior art ceramic.

### BRIEF SUMMARY OF THE INVENTION

The present invention provides a method for making a rare earth doped polycrystalline ceramic laser gain medium by hot pressing a rare earth doped polycrystalline powder where the doping concentration is greater than 2% and up to 10% and where the grain size of the final ceramic is greater than 2 μm. The polycrystalline powder can be Lu₂O₃, Y₂O₃, or Sc₂O₃, and the rare earth dopant can be Yb³⁺, Er³⁺, Tm³⁺, or Ho³⁺. The rare earth doped polycrystalline ceramic laser gain medium prepared by this method has an efficiency up to 74% and an output power of 16 W or greater.

The present invention provides a method to fabricate high optical quality rare earth doped Lu₂O₃ polycrystalline ceramic laser gain medium with average grain size of 2˜100 μm by hot pressing, resulting in the highest efficiency, highest output power, and highest doping concentration that has never before been obtained from Lu₂O₃ ceramics. Additionally, the present invention also paves the way forward for better thermal management compared with yttrium aluminum garnet (YAG) and other sesquioxide hosts such as Y₂O₃ and Sc₂O₃ especially at higher doping concentration of >2%. Possible future applications for ceramic lasers include environmental measurements, high-speed metal machining (for example, cutting and welding), cutting-edge medical devices for surgery and diagnostic tools, laser guidance systems, RGB light sources for projectors and laser television, laser drivers for nuclear fusion, and high energy laser systems for various military applications.

These and other features and advantages of the invention, as well as the invention itself, will become better understood by reference to the following detailed description, appended claims, and accompanying drawings.

### BRIEF DESCRIPTION OF THE DRAWINGS

FIG. 1 is a plot showing XRD patterns of the precursor (a) and synthesized 10% Yb doped Lu₂O₃ powder (b). The pattern for cubic Lu₂O₃, space group Ia3 as identified by PDF# 12-0728 is identified in FIG. 1.

FIG. 2(a) shows transmission plots of the optically polished ceramics fabricated from the synthesized 10% Yb: Lu₂O₃ powder and commercial Lu₂O₃ powder. Thickness of the corresponding ceramics are 2.44 mm and 2.97 mm, respectively. A theoretical transmission of Lu₂O₃ is also shown for comparison. FIGS. 2(b) and (c) show photographs of ceramics fabricated using commercial powder and co-precipitated 10% Yb:Lu₂O₃ powder, respectively.

FIG. 3 is a plot of output power versus absorbed power for a hot pressed 10% Yb³⁺ doped Lu₂O₃ ceramic laser using different output couplers. The insert shows the typical grain size of 10∫50 μm of the corresponding ceramic.

### DETAILED DESCRIPTION OF THE INVENTION

The present invention provides a general method for achieving high efficiency lasing from rare earth doped polycrystalline ceramics including Yb³⁺ doped Lu₂O₃ where the ceramic sample is obtained by hot pressing the corresponding powder. The average grain size of the final ceramic is greater than 2 μm. The doping concentration is greater than 2%, and the dopant is selected from rare earth metals such as but not limited to Yb³⁺, Er³⁺, Tm³⁺, and Ho³⁺. The method of fabricating 10% Yb³⁺ doped Lu₂O₃ ceramics according to the present invention is by hot pressing where a high efficiency laser oscillation and output power is observed from large grain size of 2˜100 μm.

The Yb³⁺ doped Lu₂O₃ powder was made by coprecipitation following the procedure outlined in Kim et al., J. Am. Ceram. Soc., 94, 3001-3005 (2011), the entire contents of which are incorporated herein by reference. This procedure is described in the examples herein. The lasing data disclosed herein is for a sample with concentration of 10 mol:% Yb³⁺ relative to Lu³⁺, although powder and ceramics with different concentrations of Yb³⁺ as well as other rare earth dopants such as Er³⁺, Tm³⁺, and Ho³⁺ were also made. Ceramics were made by hot pressing the powder using a uniform coating of a small amount of sintering aid if necessary. To remove the remaining porosity in the bulk ceramic, the hot-pressed samples were subsequently hot isostatically pressed to produce fully dense and transparent ceramics. Absorption measurements were performed on polished ceramics using a Fourier-transform IR spectrometer. The polished sample was coated with a dichroic coating for lasing experiment.

### EXAMPLE 1

### Precursor Purification

Highly pure Lu and Yb precursor crystals were obtained by first dissolving appropriate amounts of Lu₂O₃ and Yb₂O₃ powder in hot HNO₃/H₂O. The solution was filtered with a 0.45 μm membrane filter to remove any insoluble impurities and particles. The solution was boiled off until it reached saturation and slowly cooled down to form a mixture of crystalline Lu and Yb nitrates. The recrystallization was repeated three times to obtain a highly purified nitrates mixture.

### EXAMPLE 2

### Powder Synthesis

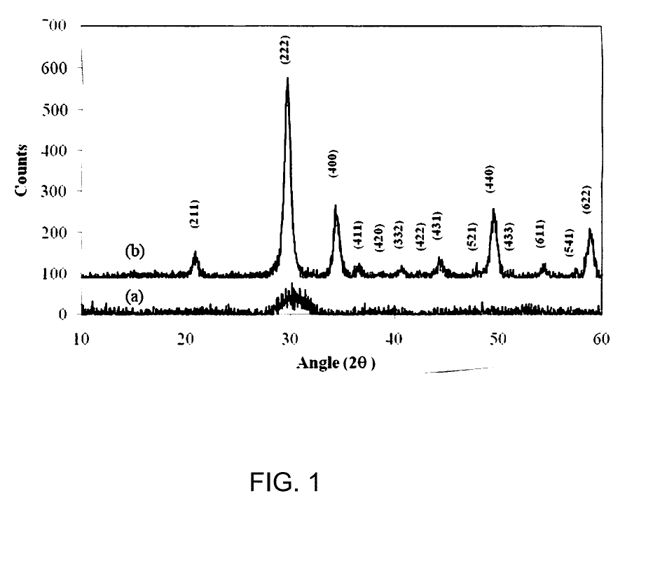

Lu₂O₃ powders doped with Yb³⁺ in various doping concentrations (0.1%, 1%, 2%, 5%, 8%, and 10%) were synthesized by the co-precipitation method. Most of the results reported herein refer to a concentration of 10% Yb³⁺, although powder and ceramics were made with different concentrations of Yb³⁺ as well as other rare earth dopants. Commercial oxide powders, including Lu₂O₃ and Yb₂O₃ were obtained from Standford Materials (Aliso Viejo, Calif.). Nitric acid (99.999%), ammonium hydroxide (99.99+%), and acetone (electronic grade) were purchased from Alfa Aesar and used as received. The mixed crystal obtained by the procedure described in Example 1 was dissolved in de-ionized H₂O and was added dropwise slowly into a warm H₂O/ammonium hydroxide solution (˜60-80° C.) at a constant rate (˜10-20 ml/min) using a peristaltic pump under vigorous stiffing. The solution pH was maintained between 8.5 and 10 by adding ammonium hydroxide. The temperature of the reaction bath was maintained between 60° C. and 80° C. A white precipitate started to form, and the reaction mixture was stirred for 1 hour and cooled to room temperature. The cooled mixture was washed with de-ionized water 5 times and finally 2 times with acetone. The wet precursor powder was dried at ˜110° C. for 24 hours. Yb doped Lu₂O₃ powder was obtained by calcination of the dried precursor powder at 600° C. for 6 hours in air. FIG. 1 shows the XRD pattern of the powder. Table 1 summarizes the chemical impurity of the powder synthesized in this method using the precursor purified by the method described in Example 1 and compares with the one from commercial powder.

TABLE 1
Chemical analysis results of the starting powders and
synthesized 10% Yb:Lu₂O₃ powder. (Units in ppm)

| | Starting Lu₂O₃ | Starting Yb₂O₃ | Synthesized 10% Yb Lu₂O₃ |
|---|---|---|---|
| Na | 13 | 250 | . |
| Al | 11 | . | 1.3 |
| Si | 88 | 19 | 3.5 |
| P | 2.3 | . | 1.8 |
| S | 88 | 660 | 62 |
| Cl | ~0.1 wt % | ~0.11 wt % | 60 |
| K | 14 | 9.5 | . |
| Ca | 9.7 | 11 | . |
| Mn | . | 18 | . |
| Fe | 1.3 | 1.1 | . |
| Zn | . | 48 | . |
| Dy | . | 6.2 | . |
| Tm | . | 7.2 | . |
| Yb | 15 | Matrix | Matrix |
| Lu | Matrix | =<11 | Matrix |
| W | . | 2.8 | . |
| Pb | . | 1.3 | . |

### EXAMPLE 3

### Ceramic Fabrication

The Yb³⁺ Lu₂O₃ powder was mixed with a sintering aid (lithium fluoride), placed in a graphite-foil (Graftec grade GTA, Cleveland, Ohio) lined graphite die, and hot pressed at 1500-1700° C. for 2-6 hours at a pressure of 50 MPa. Samples were 99% of theoretical density. At this point the samples were transparent, but there was visible scattering due to residual porosity that would not have allowed lasing. Samples were then HIPed at 1300-1800° C. in argon at 200 MPa for 5 hours and optically polished. Ceramics using commercial Lu₂O₃ powder was fabricated by a similar method without purification of the powder.

### EXAMPLE 4

### Lasing Performance

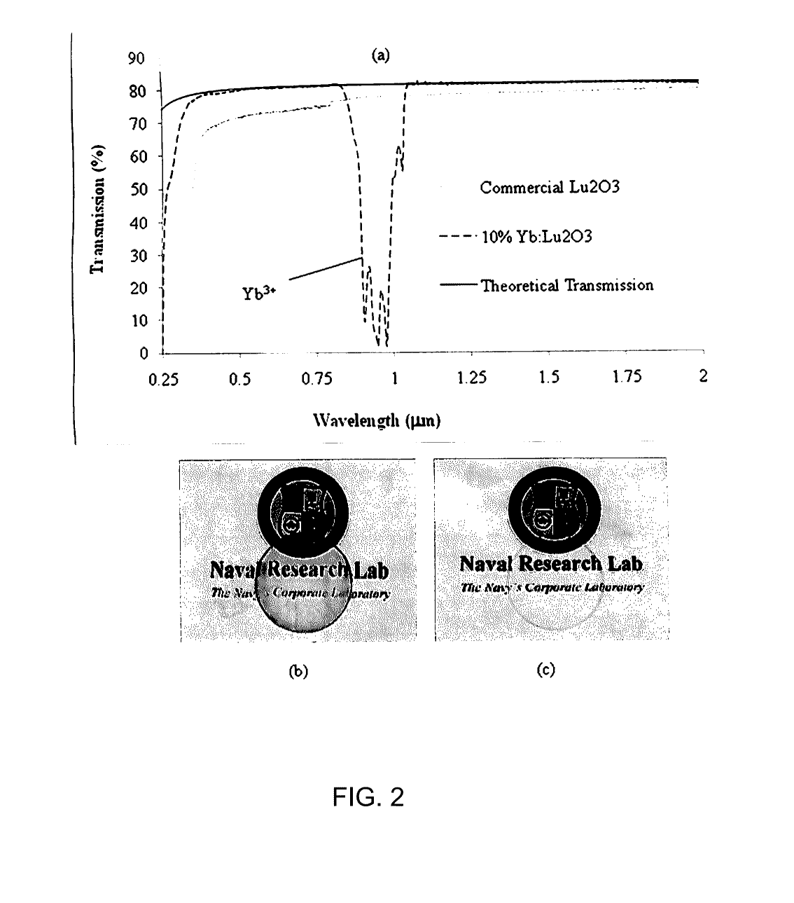

Small 3 mm diameter samples of 10% Yb³⁺: Lu₂O₃ ceramic with 2 mm thickness were obtained by core drilling from the large 25 mm diameter samples and polishing both surfaces to a high optical quality (<2 nm rms surface roughness). FIG. 2(a) shows the optical transmission plot of the optically polished ceramics fabricated from the synthesized 10% Yb doped Lu₂O₃ powder and from the commercial Lu₂O₃ powder. It is clearly seen that the transmission of the ceramic obtained form the powder synthesized by the method of the present invention is much higher than the one from commercial powder. A theoretical transmission calculated using the refractive index measured by VUV-VASE and IR-VASE spectroscopic ellipsometers (J.A. Woollam Company) is also shown. As seen in FIG. 2(a), transmission of the Yb:Lu₂O₃ is very close to the theoretical limit, which is a good indication of the excellent quality of the transparent ceramic. FIGS. 2(b) and (c) show the photographs of the corresponding ceramics. Ceramics fabricated using commercial powder typically result in grey with darkened edge and sometimes show multiple cracks. This might be due to hard agglomerates that make it difficult to densify into a uniform and transparent ceramic. The low chemical impurity of the commercial powder may cause darkening of the ceramic.

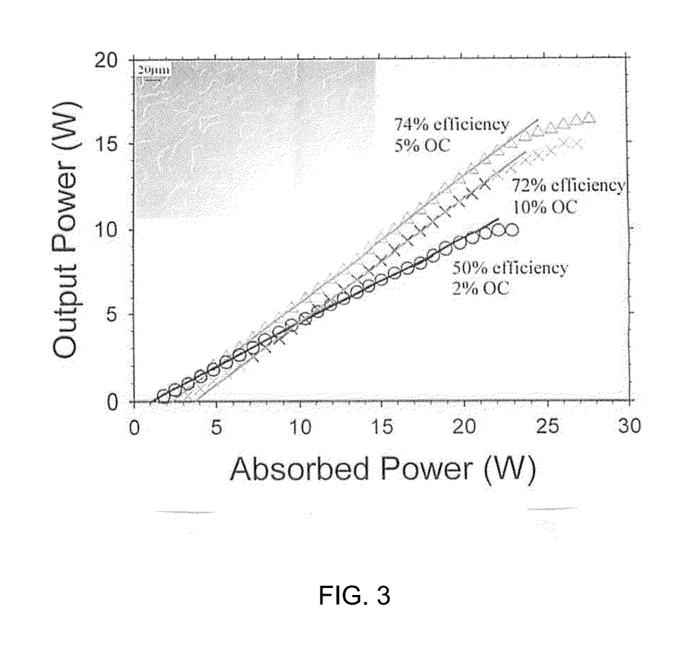

One surface was coated with a dichroic coating with high reflectivity (>99.9%) at the laser wavelength of 1080 nm and high transmission at the pump wavelength of 975 nm. An antireflective coating for 1080 nm was applied to the sample's other surface. The sample was wrapped along its circumference with a thin piece of indium foil and inserted into a copper heat sink that was cooled with chilled water to 15° C. A fiber-coupled 975 nm diode laser (LIMO GmbH) with a maximum output power of 100 W was used as a pump. The pump beam was collimated and then focused to a spot with a diameter of 290 μm. A dielectric minor with a radius of curvature of 25 cm was placed approximately 1 cm from the output surface of the sample to act as the laser's output coupler. Several mirrors, with reflectivities of 90%, 95%, and 98% at 1080 nm were tested to find the optimum output coupling. The laser was operated quasi-cw by pumping with a 50% duty cycle at 127 Hz. FIG. 3 shows the laser output power versus absorbed power measured using three different output couplers. The highest slope efficiency of 74% and a maximum output power of more than 16 W were obtained using a 5% output coupler. This represents the highest output power demonstrated to date using any Yb³⁺ doped Lu₂O₃ ceramic.

The above descriptions are those of the preferred embodiments of the invention. Various modifications and variations are possible in light of the above teachings without departing from the spirit and broader aspects of the invention. It is therefore to be understood that the claimed invention may be practiced otherwise than as specifically described. Any references to claim elements in the singular, for example, using the articles “a,” “an,” “the,” or “said,” is not to be construed as limiting the element to the singular.

What is claimed as new and desired to be protected by Letters Patent of the United States is:

1. A method for making a rare earth doped polycrystalline ceramic laser gain medium, comprising:
hot pressing a rare earth doped polycrystalline powder;
wherein the doping concentration is greater than 2%; and
wherein the grain size of the final ceramic is greater than 2 μm.

2. The method of claim 1, wherein the polycrystalline powder comprises Lu₂O₃, Y₂O₃, Sc₂O₃, or any combination thereof.

3. The method of claim 1, wherein the rare earth dopant comprises Yb³⁺, Er³⁺, Tm³⁺, Ho³⁺, or any combination thereof.

4. The method of claim 1, wherein the doping concentration is 10%.

5. The method of claim 1, wherein a sintering aid is used in the hot pressing.

6. The method of claim 5, wherein the sintering aid is lithium fluoride.

7. The method of claim 1, wherein the resulting laser gain medium has an efficiency of up to 74%.

8. The method of claim 1, wherein the resulting laser gain medium has an output power of 16 W or greater.

9. A rare earth doped polycrystalline ceramic laser gain medium made by the method, comprising:
hot pressing a rare earth doped polycrystalline powder;
wherein the doping concentration is greater than 2%; and
wherein the grain size of the final ceramic is greater than 2 μm.

10. The rare earth doped polycrystalline ceramic laser gain medium of claim 9, wherein the polycrystalline powder comprises Lu₂O₃, Y₂O₃, Sc₂O₃, or any combination thereof.

11. The rare earth doped polycrystalline ceramic laser gain medium of claim 9, wherein the rare earth dopant comprises Yb³⁺, Er³⁺, Tm³⁺, Ho³⁺, or any combination thereof.

12. The rare earth doped polycrystalline ceramic laser gain medium of claim 9, wherein the doping concentration is 10%.

13. The rare earth doped polycrystalline ceramic laser gain medium of claim 9, wherein a sintering aid is used in the hot pressing.

14. The rare earth doped polycrystalline ceramic laser gain medium of claim 13, wherein the sintering aid is lithium fluoride.

15. The rare earth doped polycrystalline ceramic laser gain medium of claim 9, wherein the laser gain medium has an efficiency of up to 74%.

16. The rare earth doped polycrystalline ceramic laser gain medium of claim 9, wherein the laser gain medium has an output power of 16 W or greater.
